(19) United States
(12) Patent Application Publication
(10) Pub. No.: US 2018/0347481 A1
(43) Pub. Date: Dec. 6, 2018

(54) CONTROL APPARATUS FOR INTERNAL COMBUSTION ENGINE

(71) Applicant: HONDA MOTOR CO., LTD., Tokyo (JP)

(72) Inventors: Kohei Chida, Wako-shi (JP); Shusuke Akazaki, Wako-shi (JP)

(73) Assignee: HONDA MOTOR CO., LTD., Tokyo (JP)

(21) Appl. No.: 15/780,887

(22) PCT Filed: Oct. 5, 2016
(86) PCT No.: PCT/JP2016/079675

§ 371 Date: Jun. 1, 2018

(30) Foreign Application Priority Data
Dec. 2, 2015 (JP) 2015-235800

(51) Int. Cl. F02D 35/02; F02D 41/14

(52) U.S. Cl. CPC F02D 35/024; F02D 2041/1433; F02D 41/1401; F02D 35/028

(57) ABSTRACT

A control apparatus for an internal combustion engine, which is capable of calculating engine parameters required for controlling the engine, particularly a combustion parameter, based on a result of detection by an in-cylinder pressure sensor, accurately in real time, thereby making it possible to improve the controllability of the engine. The control apparatus includes an in-cylinder pressure sensor for detecting in-cylinder pressure PCYL in a cylinder, a plant model provided in an electronic control unit and including a combustion model for calculating a heat release rate using the detected in-cylinder pressure PC for calculating engine parameters (the heat release rate, intake manifold pressure Pin, EGR temperature Iegr, EGR pressure Pegr) indicative of states of the engine, including the heat release rate, and an engine controller provided in the electronic control unit, for controlling the engine using the engine parameters calculated by the plant model.

### TECHNICAL FIELD

The present invention relates to a control apparatus for an internal combustion engine, which calculates engine parameters indicative of a state of the engine by using a plant model and controls the engine according to a result of the calculation.

### BACKGROUND ART

In recent years, as regulations of exhaust gas and fuel consumption of an internal combustion engine are made stricter, sensors and devices provided for clearing the regulations increase in number and type, and accordingly the number of inputs of detection signals to an ECU (electronic control unit) tends to increase, causing an increase in costs. For this reason, in order to achieve cost reduction and improve controllability, a plant model (virtual sensor) is developed which estimates a state of the engine by calculation instead of detecting the same by a sensor.

In a control apparatus for the engine, which is disclosed e.g. in PTL 1, a plurality of target value candidates of an EGR ratio are set for EGR control, and for each of the plurality of target value candidates, a future value of an EGR valve opening degree is predicted using the plant model, and a plurality of model parameters of the plant model are individually learned. Further, the control apparatus includes a multi-core processor equipped with a number of processor cores, and a prediction task of a future value associated with each target value candidate and a learning task of each model parameter are assigned to different ones of the cores.

### CITATION LIST

### Patent Literature

[PTL 1] Japanese Laid-Open Patent Publication (Kokai) No. 2013-228859

### SUMMARY OF INVENTION

### Technical Problem

As described above, in the conventional control apparatus, to the processor cores, the future value prediction tasks are assigned, on a target value candidate basis, and the learning tasks are assigned, on a model parameter basis, respectively, and the many processor cores are used for predicting the future values and learning the model parameters. Such use of the processor cores is not realistic for a limited performance of a microcomputer normally installed on a vehicle, and can cause trouble in calculating other parameters which indicate states of the engine and are necessary for controlling the engine.

For example, it is known that pressure in a cylinder of the engine is detected by an in-cylinder pressure sensor, and from a result of the detection, there are acquired combustion parameters indicative of a combustion state in the cylinder, such as pressure, heat, and energy, which are generated by combustion. Such combustion parameters are very effective for controlling the engine since they excellently reflect an actual combustion state in the cylinder. On the other hand, to obtain effective combustion parameters, it is desirable to sequentially analyze the result of detection by the in-cylinder pressure sensor on a combustion cycle basis. In this case, calculation load is very large. In the above-described conventional control apparatus, since calculation performance is limited, there is a fear that calculation of the combustion parameters cannot be performed satisfactorily.

The present invention has been made to provide a solution to the above-described problems, and an object thereof is to provide a control apparatus for an internal combustion engine, which is capable of calculating engine parameters necessary for controlling the engine, particularly a combustion parameter, based on a result of detection by an in-cylinder pressure sensor, accurately in real time, thereby making it possible to improve the controllability of the engine.

### Solution to Problem

To attain the above object, the invention according to claim 1 is a control apparatus for an internal combustion engine, comprising an in-cylinder pressure sensor 21 that detects pressure in a cylinder 3a, a plant model (model calculation section 42) that is provided in an electronic control unit 2, and includes a combustion model for calculating a combustion parameter (heat release rate dQd θ) indicative of a combustion state in the cylinder 3a using a result of detection (in-cylinder pressure PCYL in the embodiment (hereinafter, the same applies throughout this section)) by the in-cylinder pressure sensor 21, for calculating engine parameters (heat release rate dQd θ, intake manifold pressure Pin, EGR temperature Tegr, EGR pressure Pegr) indicative of states of the engine 3, including the combustion parameter, a controller (engine controller 43) that is provided in the electronic control unit 2, for controlling the engine 3 using the engine parameters calculated by the plant model.

According to this configuration, since the combustion model included in the plant model calculates the combustion parameter using the result of detection by the in-cylinder pressure sensor, it is possible to accurately calculate the combustion parameter while causing an actual pressure generated in the cylinder to be reflected thereon. Further, since the combustion model and the controller for controlling the engine using the combustion parameter are provided in the single electronic control unit, it is possible for the controller to use the combustion parameter calculated by the combustion model in real time without communication delay. From the above, it is possible to improve the controllability of the engine using the combustion parameter. Further, since a plant model other than the combustion model calculates engine parameters other than the combustion parameter, it is possible to omit sensors provided for detecting the parameters, whereby it is possible to achieve cost reduction.

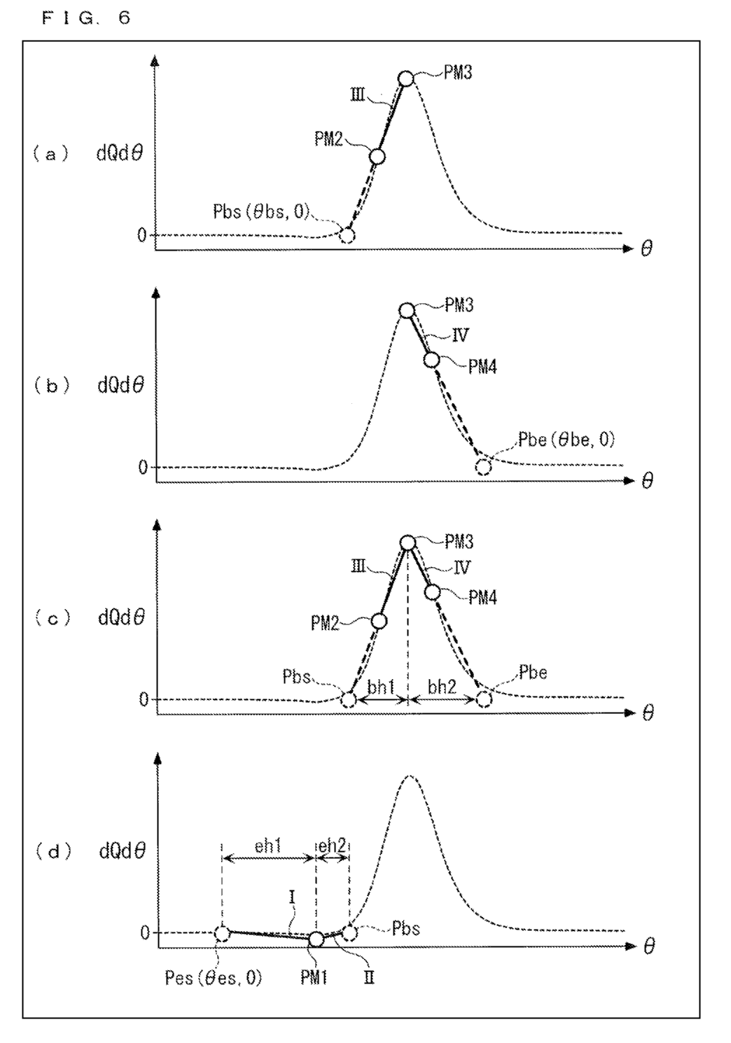

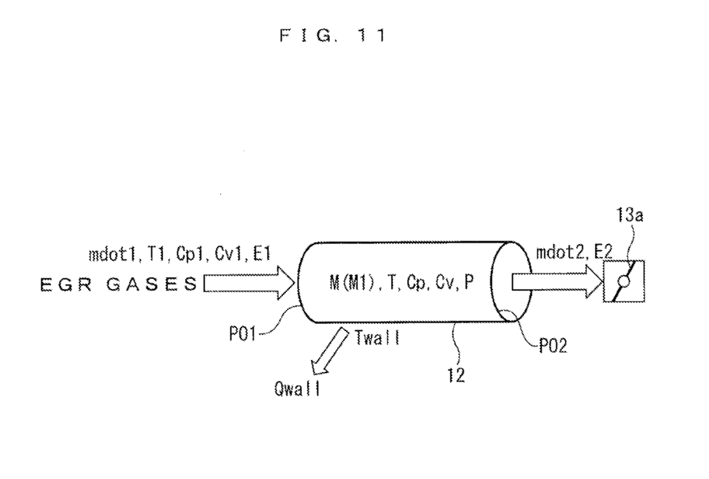

The invention according to claim 2 is the control apparatus according to claim 1, wherein the combustion parameter is a heat release rate dQd θ, and the combustion model calculates the heat release rate dQd θ using a linear function model equation (FIG. 5, FIG. 6) obtained by approximating a Wiebe function which is an approximate function of the heat release rate dQd θ by a plurality of linear functions (steps 12 and 13 in FIG. 9).

According to this configuration, the heat release rate as the combustion parameter is calculated using the linear function model equation obtained by approximating the Wiebe function by the plurality of linear functions. The Wiebe function, known as an approximate function of the heat release rate, has a relatively simple overall shape, and includes a large number of portions having a shape close to a straight line. This makes it possible to accurately approximate the Wiebe function by the plurality of linear functions. Further, the load of calculating the heat release rate using the linear function model equation formed by the plurality of linear functions is much lower than when using the Wiebe function. Therefore, it is possible to responsively perform the calculation of the heat release rate in a short time period while maintaining its accuracy, whereby it is possible to further improve the control of the engine, which uses the heat release rate.

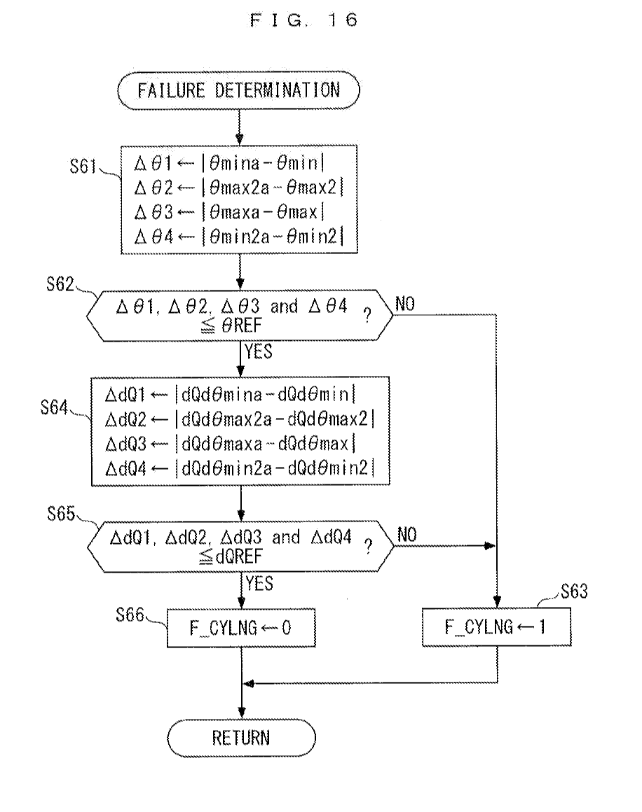

The invention according to claim 3 is the control apparatus according to claim 2, wherein the linear function model equation includes a plurality of model parameters (first to fourth model reference points PM1 to PM4), and the combustion model includes identification means (model calculation section 42, FIG. 15) for identifying the plurality of model parameters in real time based on the result of detection by the in-cylinder pressure sensor 21.

According to this configuration, the plurality of model parameters of the linear function model equation are identified in real time based on the result of detection by the in-cylinder pressure sensor, and hence it is possible to properly compensate for a modeling error of the linear function model equation due to variation in combustion states, aging, etc., as occasion arises, thereby making it possible to maintain excellent accuracy of calculation of the heat release rate.

The invention according to claim 4 is the control apparatus according to any one of claims 1 to 3, wherein the electronic control unit 2 includes a plurality of processor cores 41 to 43, and a combustion calculator (CPS calculation section 41) for performing combustion calculation using the result of detection by the in-cylinder pressure sensor 21, the plant model (model calculation section 42), and the controller (engine controller 43) are mounted on the plurality of processor cores 41 to 43 separately from each other.

According to this configuration, the combustion calculator for performing combustion calculation using the result of detection by the in-cylinder pressure sensor, the plant model, and the controller are mounted on the plurality of processor cores of the electronic control unit separately from each other. This makes it possible not only to perform each of the combustion calculation by the combustion calculator, the calculation of the engine parameters by the plant model, and the control of the engine by the controller, at a high calculation speed or a high control speed, but also to responsively supply and receive data to and from each other, so that it is possible to further improve the controllability of the engine.

The invention according to claim 5 is the control apparatus according to any one of claims 1 to 4, wherein the engine 3 includes a fuel injection valve 4 for injecting fuel directly into each cylinder 3a, and wherein the in-cylinder pressure sensor 21 is integrally provided on the fuel injection valve 4.

According to this configuration, the in-cylinder pressure sensor is integrally provided on the fuel injection valve, and hence compared with an in-cylinder pressure sensor having a washer-shaped detection section disposed between a device, such as the fuel injection valve or a spark plug, and a cylinder head, it is possible to more accurately detect the in-cylinder pressure while suppressing the influence of vibration of the cylinder head. With this, it is possible to further enhance the accuracy of calculating the combustion parameter using the result of detection by the in-cylinder pressure sensor, whereby it is possible to further improve the controllability of the engine.

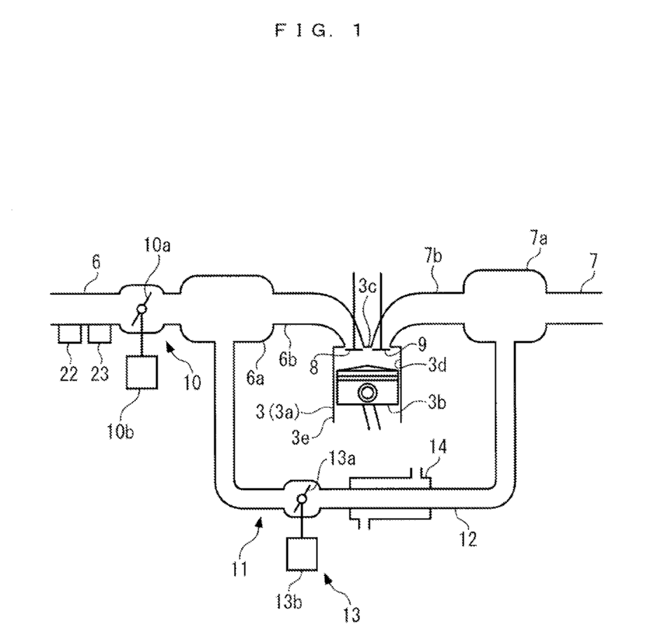

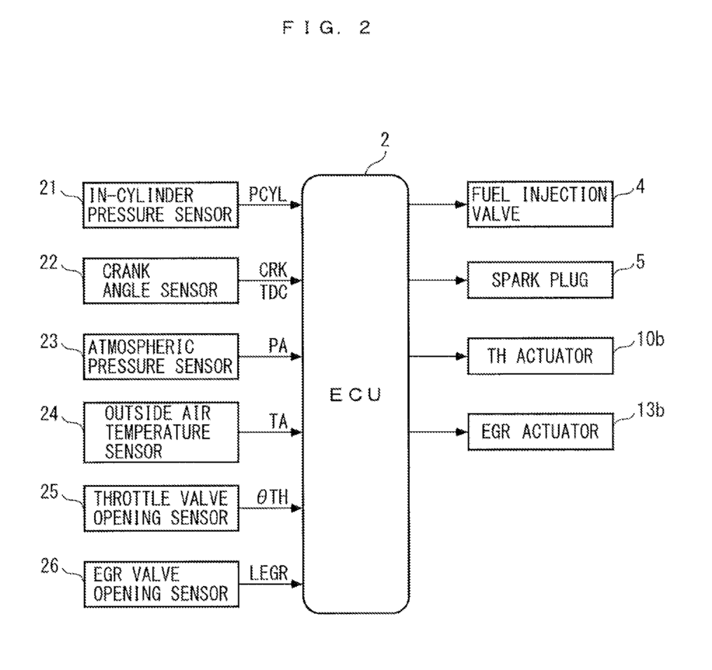

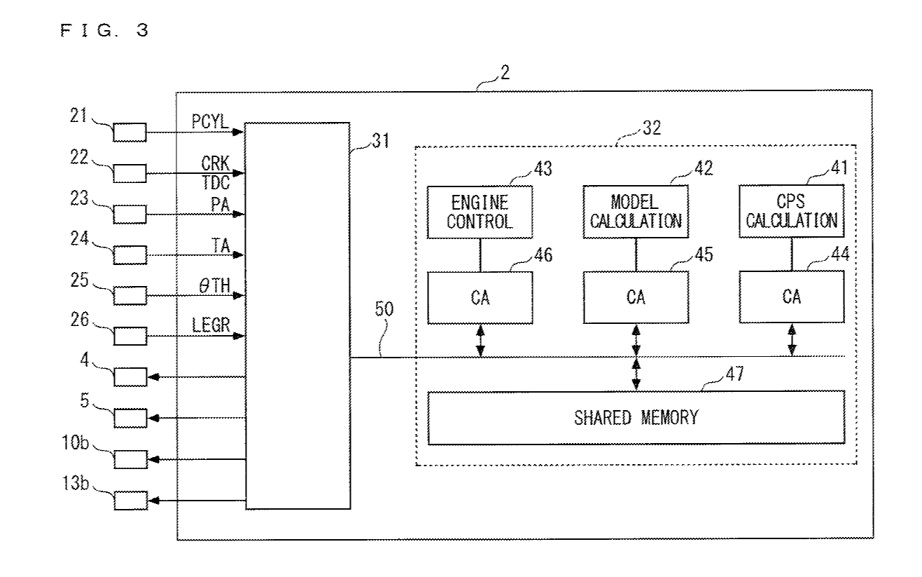

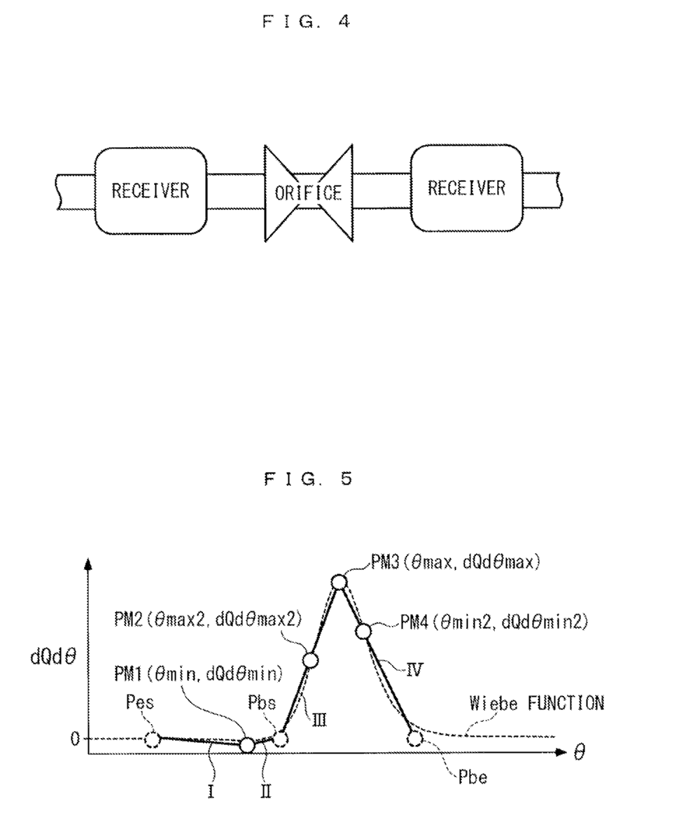

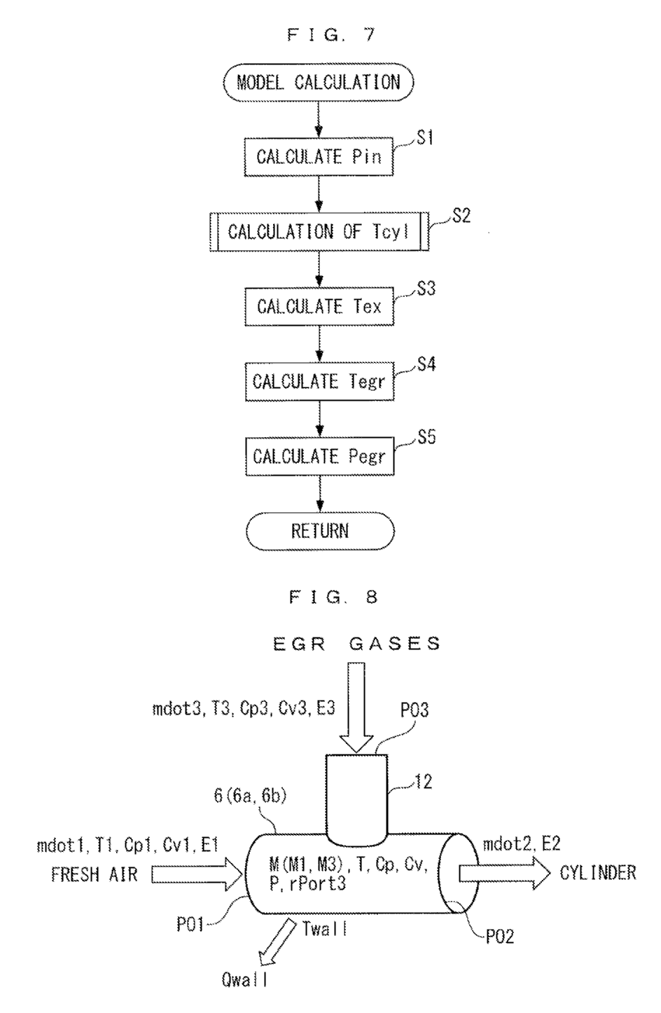

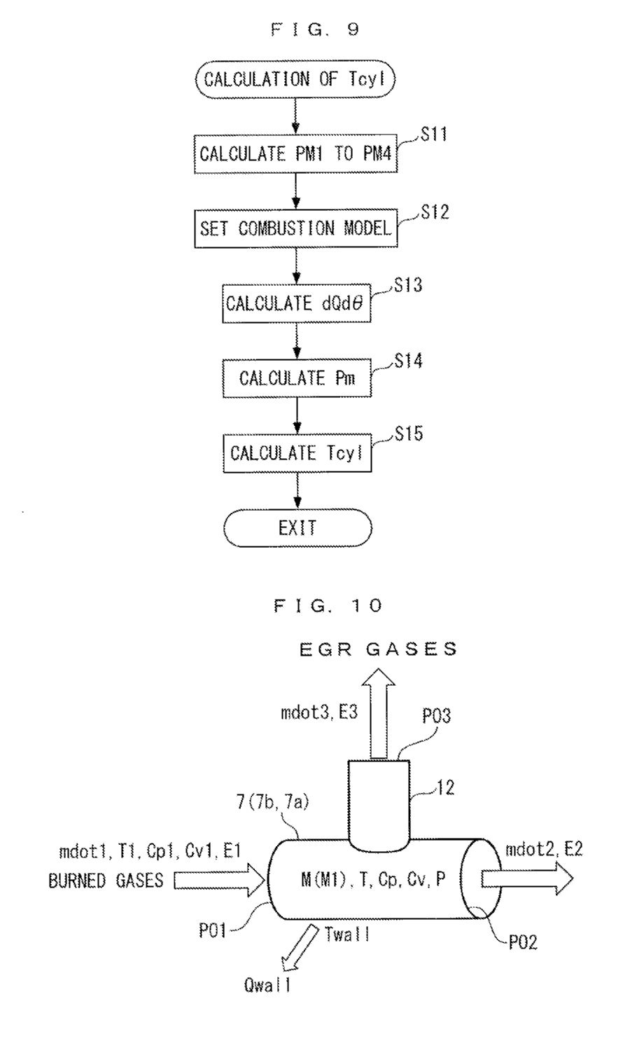

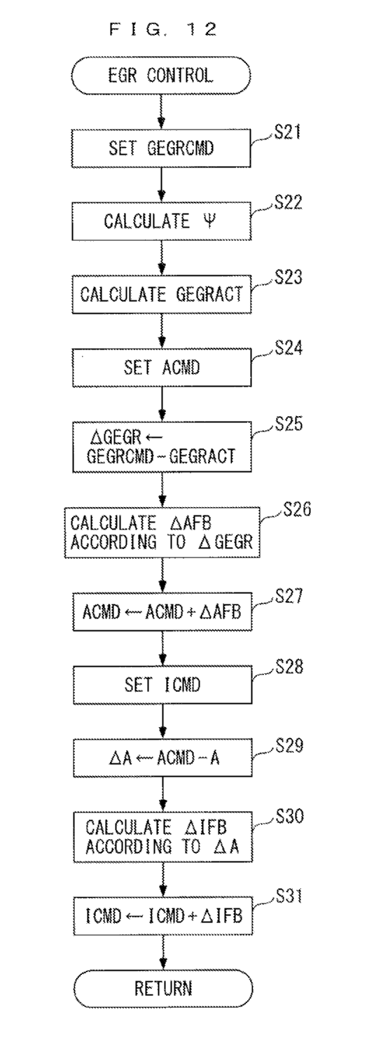

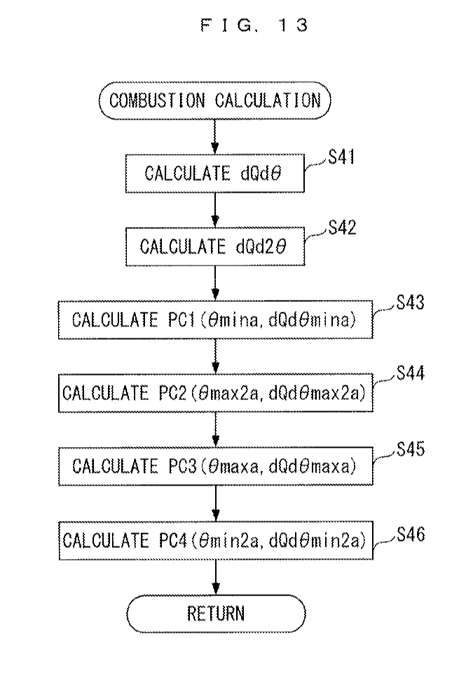

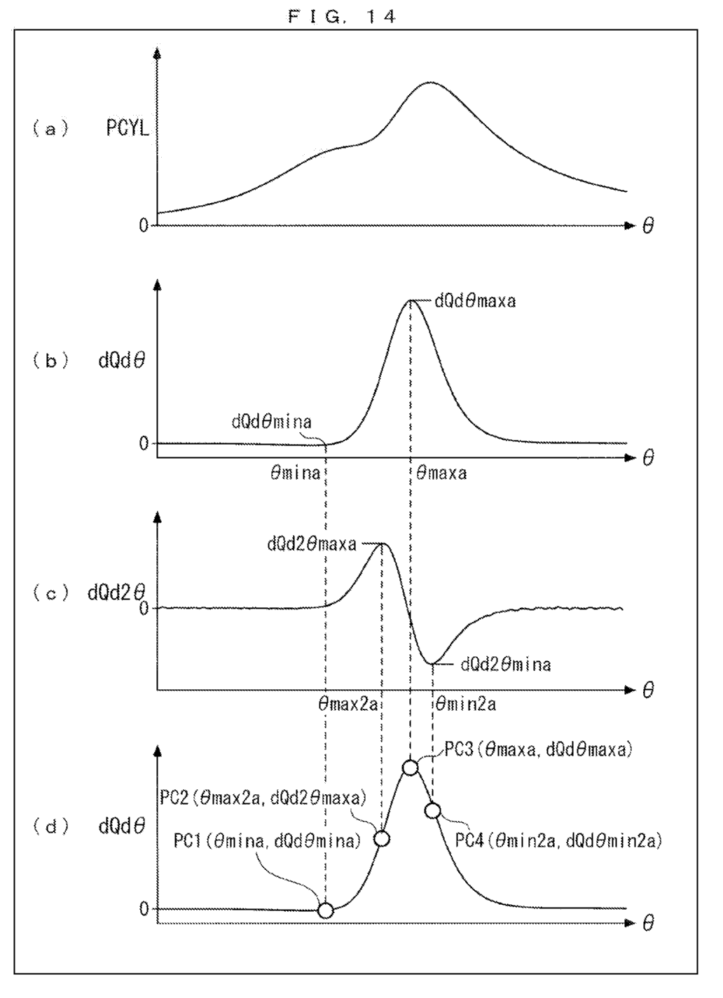

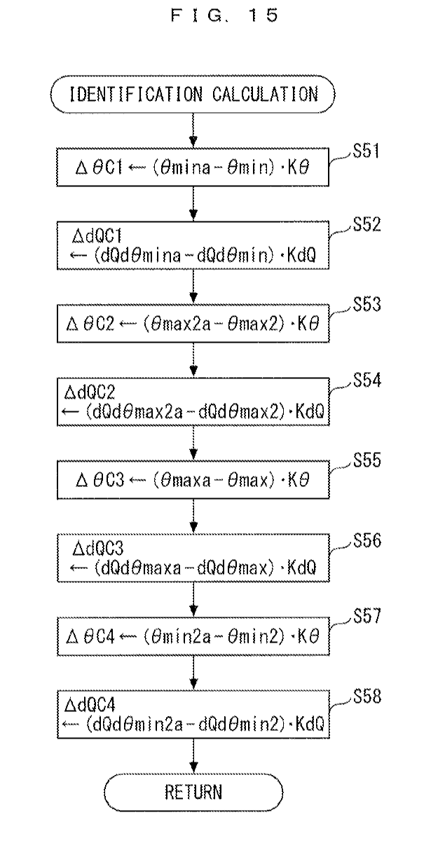

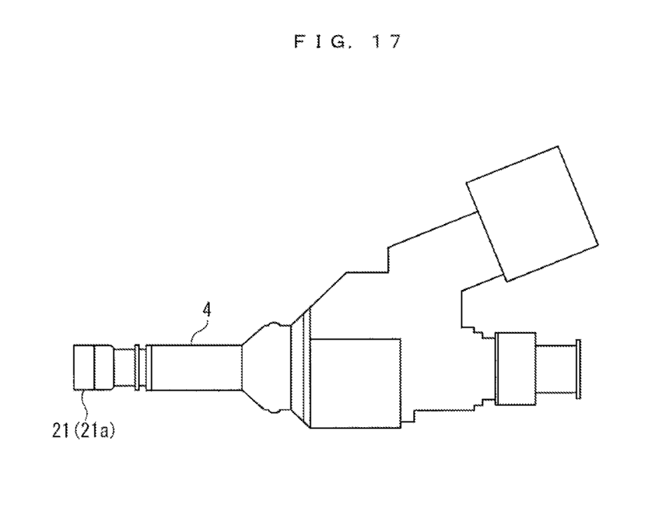

### BRIEF DESCRIPTION OF DRAWINGS

[FIG. 1] A schematic diagram of an internal combustion engine to which the present invention is applied.

[FIG. 2] A block diagram of a control apparatus for the internal combustion engine.

[FIG. 3] A diagram showing details of the control apparatus shown in FIG. 2.

[FIG. 4] A conceptual diagram of an air system model .

[FIG. 5] A diagram of a combustion model for calculating a heat release rate.

[FIG. 6] Diagrams useful in explaining a method of setting the combustion model.

[FIG. 7] A flowchart of a model calculation process.

[FIG. 8] A diagram showing an intake manifold model together with a relationship between input and output of parameters of gases.

[FIG. 9] A flowchart of an in-cylinder temperature calculation process.

[FIG. 10] A diagram showing an exhaust manifold model together with a relationship between input and output of parameters of gases.

[FIG. 11] A diagram showing an EGR passage model on an upstream side of an EGR valve together with a relationship between input and output of parameters of gases.

[FIG. 12] A flowchart of an EGR control process.

[FIG. 13] A flowchart of a combustion calculation process for calculating correction reference points.

[FIG. 14] Diagrams useful in explaining a method of calculating the correction reference points.

[FIG. 15] A flowchart of an identification process for identifying model reference points.

[FIG. 16] A flowchart of a failure determination process for determining a failure of an in-cylinder pressure sensor.

[FIG. 17] A diagram showing the appearance of a fuel injection valve and the in-cylinder pressure sensor integrally provided thereon.

### DESCRIPTION OF EMBODIMENTS

Hereafter, a preferred embodiment of the present invention will be described in detail with reference to drawings. FIG. 1 shows an internal combustion engine (hereinafter referred to as the “engine”) 3 to which the present invention is applied. The engine 3 is e.g. a four-cylinder gasoline engine installed on a vehicle (not shown). A combustion chamber 3d is defined between a piston 3b and a cylinder head 3c of each of the cylinders 3a (only one of which is shown) of the engine 3.

Each cylinder 3a has an intake passage 6 connected thereto via an intake manifold 6b having an intake collector 6a, with an intake valve 8 provided therein, and has an exhaust passage 7 connected thereto via an exhaust manifold 7b having an exhaust collector 7a, with an exhaust valve 9 provided therein. Further, a fuel injection valve 4 and a spark plug 5 (see FIG. 2) are provided for each cylinder 3a such that they face a combustion chamber 3d. The amount and timing of fuel injection by the fuel injection valve 4, and ignition timing of the spark plug 5 are controlled by control signals delivered from an electronic control unit (hereinafter referred to as the “ECU”) 2, described hereinafter. Furthermore, each cylinder 3a is provided with an in-cylinder pressure sensor 21 for detecting an in-cylinder pressure PCYL which is pressure in the cylinder 3a (see FIG. 2). As shown in FIG. 17, the in-cylinder pressure sensor 21 is an integral type which is integrally provided on the fuel injection valve 4, and includes a ring-shaped pressure detection element 21a disposed at a tip end portion of the fuel injection valve 4, and an amplification circuit unit (not shown). The pressure detection element 21a detects a rate of change in the in-cylinder pressure PCYL. The amplification circuit unit filters and amplifies a detection signal output from the pressure detection element 21a, and after converting the signal to the in-cylinder pressure PCYL, outputs a detection signal thereof to an ECU 2. Since thus integrally provided at the tip end portion of the fuel injection valve 4, the in-cylinder pressure sensor 21 is capable of more accurately detecting the in-cylinder pressure PCYL while suppressing the influence of vibration of the cylinder head 3c, than a general washer type in-cylinder pressure sensor.

A throttle valve mechanism 10 is provided in the intake passage 6 at a location upstream of the intake collector 6a. The throttle valve mechanism 10 includes a butterfly type throttle valve 10a disposed in the intake passage 6, and a TH actuator 10b for actuating the throttle valve 10a. An opening of the throttle valve 10a (hereinafter referred to as the “throttle valve opening”) θ TH is controlled by controlling electric current supplied to the TH actuator 10b by the ECU 2, whereby the amount of fresh air supplied to the combustion chamber 3d is adjusted.

Further, the engine 3 is provided with an EGR device 11 for recirculating part of exhaust gases discharged from the combustion chamber 3d into the exhaust passage 7, to the intake passage 6, as EGR gases. The EGR device 11 is comprised of an EGR passage 12, an EGR valve mechanism 13 provided in an intermediate portion of the EGR passage 12, and an EGR cooler 14. The EGR passage 12 is connected to the exhaust collector 7a of the exhaust passage 7 and the intake collector 6a of the intake passage 6.

The EGR valve mechanism 13 includes a poppet-type EGR valve 13a disposed in the EGR passage 12, and an EGR actuator 13b for actuating the EGR valve 13a. A lift amount of the EGR valve 13a (hereinafter referred to the “EGR valve opening”) LEGR is controlled by controlling electric current supplied to the EGR actuator 13b by the ECU 2, whereby an EGR amount of EGR gases recirculated to the intake passage 6 is adjusted.

The crankshaft of the engine 3 is provided with a crank angle sensor 22 (see FIG. 2). The crank angle sensor 22 delivers a CRK signal and a TDC signal, which are pulse signals, to the ECU 2 along with rotation of the crankshaft. Each pulse of the CRK signal is delivered whenever the crankshaft rotates through a predetermined crank angle (e.g. 1°). The ECU 2 calculates a rotational speed of the engine 3 (hereinafter referred to as the “engine speed”) NE based on the CRK signal.

The TDC signal indicates that the piston 3b in one of the cylinders 3a of the engine 3 is in the TDC position at the start of the intake stroke, and in a case where the engine 3 has four cylinders as in the present embodiment, each pulse of the TDC signal is delivered whenever the crankshaft rotates through a crank angle of 180°. According to the TDC signal and the CRK signal, the ECU 2 calculates the crank angle θ determined with reference to the output timing of the TDC signal for each cylinder 3a.

Further, an atmospheric pressure sensor 23 and an outside air temperature sensor 24 are provided in the intake passage 6 at respective locations upstream of the throttle 10a. The atmospheric pressure sensor 23 and the outside air temperature sensor 24 detect an atmospheric pressure PA and a temperature TA of outside air (fresh air) introduced into the intake passage 6, respectively, and deliver detection signals indicative of the detected atmospheric pressure PA and the detected temperature TA to the ECU 2.

Furthermore, to the ECU 2, a detection signal indicative of the throttle valve opening θ TH is input from a throttle valve opening sensor 25, and a detection signal indicative of the EGR valve opening LEGR is input from an EGR valve opening sensor 26.

As shown in FIG. 3, the ECU 2 includes an input/output section 31 and a multi-core processing unit (hereinafter referred to as the “MCU”) 32. The input/output section 31 is a section to which the detection signals are input from the aforementioned sensors 21 to 26, and from which drive signals are output to the fuel injection valve 4, the spark plug 5, the EGR actuator 13b, and so forth.

The MCU 32 includes first to third processor cores 41 to 43, cache memories 44 to 46 provided in association with the processor cores 41 to 43, respectively, and a shared memory 47 commonly used by the processor cores 41 to 43. The cache memories 44 to 46, the shared memory 47, and the input/output section 31 are connected to each other via a bus 50. First, data input to the input/output section 31 is stored in the shared memory 47. The processor cores 41 to 43 read out data required for calculation processing from the shared memory 47, temporarily store the data in the cache memories 44 to 46, and perform the calculation processing.

More specifically, the first processor core 41 (hereinafter referred to as the “CPS calculation section 41”) performs a combustion calculation process for calculating a combustion parameter, such as a heat release rate dQd θ, which represents a combustion state in each cylinder 3a, based on the in-cylinder pressure PCYL detected by the in-cylinder pressure sensor 21 and the crank angle θ.

The second processor core 42 (hereinafter referred to as the “model calculation section 42”) performs a model calculation process for calculating engine parameters which represent states of the engine 3, based on a plant model, described hereinafter. The engine parameters include the respective mass flow rates, temperatures, and pressures of intake air, exhaust gases, and EGR gases the intake passage 6, the exhaust passage 7, and the EGR passage 12.

Further, the third processor core 43 (hereinafter referred to as the “engine controller 43”) performs an engine control process for calculating control parameters for controlling the devices of the engine 3, such as the fuel injection valves 4, the spark plugs 5, the throttle valve 10a, and the EGR valve 13a, using the engine parameters calculated by the model calculation section 42. The calculated control parameters are sent to the input/output section 31, and are converted to drive signals by the input/output section 31, whereafter the drive signals are output to the devices.

Note that in the present embodiment, the CPS calculation section 41 corresponds to a combustion calculator, the model calculation section 42 corresponds to the plant model and identification means, and the engine controller 43 corresponds to a controller.

The plant model as a basis of the above-mentioned model calculation process is classified into an air system model and a combustion model. As shown in FIG. 4, the air system model is formed by modeling the configurations of the passages of the engine 3 (the intake passage 6, the exhaust passage 7, the EGR passage 12, and so forth) through which intake air, exhaust gases, and EGR flow, as a combination of an “orifice” portion where the throttle valve 10a, the EGR valve 13a, and so forth exist, and “receiver” portions other than the orifice portion. Further, the mass flow rate, temperature, and pressure of each of the fluids in the respective portions of the passages of the engine 3 are calculated by applying the equation of continuity (the law of conservation of mass and the law of conservation of energy) and the equation of state of the gas, to the receivers, and applying the equation of the orifice to the orifice.

On the other hand, the combustion model is formed by simplifying and modeling the Wiebe function, which is generally known as an approximate function of the heat release rate, for reducing a calculation load. More specifically, as shown in FIGS. 5 and 6, the combustion model is formed by dividing the Wiebe function (broken lines) into four periods (a first evaporation period eh1, a second evaporation period eh2, a first combustion period bh1, and a second combustion period bh2) according to the release patterns of the heat release rate, and approximating the four periods by first to fourth linear functions I to IV, respectively. Further, to set the first to fourth linear functions I to IV, the following four model reference points PM1 to PM4 are used.

The first model reference point PM1 corresponds to a point at which the heat release rate dQd θ becomes minimum immediately before the start of combustion, and is expressed by PM1=(θmin, dQd θmin) using a minimum heat release rate dQd θmin at the time and a crank angle θmin associated therewith. The second model reference point PM2 corresponds to a point at which a differential value dQd2 θof the heat release rate, calculated by differentiating the heat release rate dQd θ with respect to the crank angle θ, becomes maximum, and is expressed by PM2=(θmax2, dQd θmax2) using a maximum differential value-associated heat release rate dQd θmax2 which is a heat release rate at the time and a crank angle θmax2 associated therewith.

The third model reference point PM3 corresponds to a point at which the heat release rate dQd θbecomes maximum, and is expressed by PMP3=(θmax, dQd θmax) using a maximum heat release rate dQd θmax at the time and a crank angle θmax associated therewith. Further, the fourth model reference point PM4 corresponds to a point at which the differential value dQd2 θ of the heat release rate becomes minimum, and is expressed by PM4=(θmin2, dQd θmin2) using a minimum differential value-associated heat release rate dQd θmin2 which is a heat release rate at the time and a crank angle θmin2 associated therewith.

After the above-described four model reference points PM1 to PM4 are determined, the linear functions I to IV are set based on the determined model reference points PM1 to PM4, as follows: First, as shown in FIG. 6(a), the third linear function III is unconditionally set as a straight line (linear expression) that passes the second model reference point PM2 and the third model reference point PM3.

Specifically, assuming that the linear expression is dQd θ=A·θ+B (A: slope, B: intercept), the slope A is calculated by A=(dQd θmax−dQd θmax2)/(θmax−θmax2), and the intercept B is calculated by substituting dQd θmax, θmax, and the calculated A, in B =dQd θ−A·θ. Such a calculation method is similarly applied to a case where other linear functions, referred to hereinafter, are set. Further, by the third linear function III, a crank angle θ satisfying the heat release rate dQd θ=0 is calculated as a combustion start angle θbs, and a combustion start point Pbs (θbs, 0) is set.

Also, as shown in FIG. 6(b), the fourth linear function IV is set as a straight line that passes the third model reference point PM3 and the fourth model reference point PM4. Further, by the set fourth linear function IV, a crank angle θ satisfying the heat release rate dQd θ=0 is calculated as a combustion end angle θbe, and a combustion end point Pbe (θbe, 0) is set. Further, as shown in FIG. 6(c), a difference in crank angle θ between the third model reference point PM3 and the combustion start point Pbs (=θ)ax−θbs) is calculated as the first combustion period bhl, and a difference in crank angle θ between the combustion end point Pbe and the third model reference point PM3 (=θbe−θmax) is calculated as a second combustion period bh2.

As shown in FIG. 6(d), the first linear function I is set as a straight line that passes an evaporation start point Pes (θes, 0) and the first model reference point PM1. The evaporation start point Pes is a point at which a mixture starts to evaporate before combustion, and an evaporation start angle θes is set to a predetermined fixed value. Further, the second linear function II is set as a straight line that passes the first model reference point PM1 and the combustion start point Pbs. Furthermore, a difference in crank angle θ between the first model reference point PM1 and the evaporation start point Pes (=θmin−θes) is calculated as a first evaporation period eh1, and a difference in crank angle θ between the combustion start point Pbs and the first model reference point PM1 (=θbs −θmin) is calculated as a second evaporation period eh2.

As described above, the combustion model is set by simplifying using the first to fourth linear functions I to IV, so that the load of calculating the heat release rate dQd θ using the combustion model becomes much lower than when using the Wiebe function.

Next, the model calculation process performed by the model calculation section 42 will be described with reference to FIG. 7. This process estimates an intake manifold pressure Pin required for EGR control, and the temperature and pressure of exhaust gases immediately upstream of the EGR valve 13 as an EGR temperature Tegr and an EGR pressure Pegr, respectively, based on the above-described plant model. The present process is executed for each cylinder 3a in synchronism with generation of the CRK signal.

In the present process, first, in a step 1 (shown as S1; the same applies hereinafter), the intake manifold pressure Pin, which is an intake pressure in the intake passage 6 on the downstream side of the throttle valve 10a, is calculated. As shown in FIG. 8, the calculation of the intake manifold pressure Pin is performed by setting a portion of the intake passage 6 appearing in FIG. 1 from a portion downstream of the throttle valve 13a through the intake chamber 6a, and a connecting portion of the intake passage 6 to the EGR passage 12, as an intake manifold model (receiver), and also based on the relationship between parameters, described hereinafter, which holds in the intake manifold model.

Specifically, as shown in FIG. 8, it is assumed that the mass flow rate, temperature, constant pressure specific heat, constant volume specific heat, and energy of fresh air flowing into the receiver through a port PO1 are represented by mdot1, T1, Cp1, Cv1, and E1, respectively, and the mass flow rate, temperature, constant pressure specific heat, constant volume specific heat, and energy of EGR gases flowing into the receiver through a port PO3 are represented by mdot3, T3, Cp3, Cv3, and E3, respectively. Further, the mass (fresh air mass, EGR gas mass), temperature, constant pressure specific heat, constant volume specific heat, pressure, and EGR ratio of gases in the receiver are represented by M (M1, M3), T, Cp, Cv, P, and rPort3, respectively, and the mass flow rate and energy of gases flowing out of the receiver through a port PO2 are represented by mdot2 and E2, respectively. Then, from the equation of continuity, the equation of state of the gas, and so forth, the relationship expressed by the following equations (1) to (16) holds between the above parameters. Although the above parameters are functions of time, indication of time is omitted from the equations, for convenience' sake.

First, from the law of conservation of mass for the gases in the receiver, there holds the following equation (1), and from the law of conservation of mass for fresh air and EGR gases flowing into the receiver through the ports PO1 and PO3, there hold the following the equations (2) and (3), respectively.

$$\begin{matrix}\frac{d}{dt} M = mdot 1 - mdot 2 + mdot 3 & ( 1 ) \\ \frac{d}{dt} M 1 = mdot 1 - \frac{M 1}{M} mdot 2 & ( 2 ) \\ \frac{d}{dt} M 3 = mdot 3 - \frac{M 3}{M} mdot 2 & ( 3 )\end{matrix}$$

Further, the equations (4) and (5) hold from the relation of conservation of respective constant pressure heat capacities M1·Cp1 and M3·Cp3 of the fresh air and the EGR gases flowing into the receiver, and the equations (6) and (7) hold from the relation of conservation of respective constant volume heat capacities M1·Cv1 and M3·Cv3 of the fresh air and the EGR gases.

$$\begin{matrix}\frac{d}{dt} ( M 1 \cdot Cp 1 ) = mdot 1 \cdot Cp 1 - \frac{M 1}{M} mdot 2 \cdot Cp 1 & ( 4 ) \\ \frac{d}{dt} ( M 3 \cdot Cp 3 ) = mdot 3 \cdot Cp 3 - \frac{M 3}{M} mdot 2 \cdot Cv 3 & ( 5 ) \\ \frac{d}{dt} ( M 1 \cdot Cv 1 ) = mdot 1 \cdot Cv 1 - \frac{M 1}{M} mdot 2 \cdot Cp 1 & ( 6 ) \\ \frac{d}{dt} ( M 3 \cdot Cv 3 ) = mdot 3 \cdot Cv 3 - \frac{M 3}{M} mdot 2 \cdot Cv 3 & ( 7 )\end{matrix}$$

Further, energy (enthalpy) E1 of the fresh air flowing into the receiver, energy E2 of gases flowing out from the receiver, and energy E3 of the EGR gases flowing into the receiver are expressed by the equations (8) to (10), respectively.

E1=Cp1·Tin1·mdot1 (8)

E2=Cp·T·mdot2 (9)

E3=Cp3·Tin3·mdot3 (10)

From a relation that a constant pressure heat capacity Cp·M and a constant volume heat capacity Cv·M of the gases in the receiver are the respective sums of the fresh air portions and the EGR gas portions, the equations (11) and (12) hold.

Cp·M=Cp1·M1+Cp3·M3 (11)

Cv·M=Cv1·M1+Cv3·M3 (12)

A heat dissipation amount Qwall from the receiver to the outside is expressed by the following equation (13).

Qwall=K·Swall(T−Twall) (13)

Here, Twall represents a wall temperature of the receiver, Swall represents a wall area (constant) of the same, and K represents a heat transfer coefficient (constant) of the same.

Further, the equation (14) holds from the law of conservation of energy for the gases in the receiver.

$$\frac{d}{dt} ( T \cdot Cv \cdot M ) = E 1 - E 2 + E 3 - Qwall \qquad ( 14 )$$

Furthermore, the equation (15) holds by applying the equation of state of the gas to the receiver.

P·V=M(Cp−Cv)·T (15)

※ Cp−Cv=R

Further, the EGR ratio rPort3 of the gases in the receiver is represented by the equation (16).

$$rPort 3 = \frac{M 3}{M 1 + M 3} \qquad ( 16 )$$

By applying e.g. simultaneous equations to the above equations (1) to (16), it is possible to calculate parameters of the gases in the receiver, and the mass flow rate mdot2 and the energy E2 of the gases flowing out of the receiver, using the parameters of the fresh air and the EGR gases as known parameters. In the step 1, a pressure P in the receiver is calculated as the intake manifold pressure Pin.

Referring again to FIG. 7, in a step 2 following the step 1, an in-cylinder temperature Tcyl is calculated. This calculation process is for setting the above-described combustion model, and calculating the in-cylinder temperature Tcyl based on the set combustion model, and is performed according to a subroutine shown in FIG. 9.

In the process in FIG. 9, first, in a step 11, the model reference points PM1 to PM4 of the combustion model are calculated. This calculation is performed by searching a predetermined map (not shown) for respective map values of the model reference points PM1 to PM4, according to operating conditions of the engine 3, such as the engine speed NE, the air fuel ratio of the mixture, and ignition timing, and the EGR ratio, and correcting the map values by correction terms, described hereinafter. Further, as the above-mentioned EGR ratio, there is used, for example, the EGR ratio rPort3 calculated by the aforementioned equation (16) in the intake manifold model.

Next, the combustion model formed by the four linear functions I to IV is set by the above-described method using the calculated model reference points PM1 to PM4 (step 12), and the heat release rate dQd θ is calculated using the set combustion model (step 13). Next, an estimated in-cylinder pressure Pm based on the combustion model is calculated using the calculated heat release rate dQd θ by the following equation (17) (step 14).

Pm=dQdθ·(κ−1)/(κ·dV)−(V·dPm)/(κ·dV) (17)

Here, the amount of change dV in an in-cylinder volume V is unconditionally determined according to the crank angle θ, and an in-cylinder pressure change amount dPm is determined as a difference between two calculation timings. A specific heat ratio κ is a constant.

Next, by applying the equation of state of the gas to the cylinder 3a, the in-cylinder temperature Tcyl is calculated using the estimated in-cylinder pressure Pm, by the following equation (18) (step 15), followed by terminating the present process.

Tcyl=Pm·V/(M·R) (18)

Referring again to FIG. 7, in a step 3 following the step 2, an exhaust manifold temperature Tex, which is a temperature in the exhaust manifold 7b, is calculated. As shown in FIG. 10, the calculation of the exhaust manifold temperature Tex is performed by setting a portion of the exhaust passage 7 from the exhaust manifold 7b through the exhaust chamber 7a, and a portion of the exhaust passage 7 branching into the EGR passage 12, as an exhaust manifold model (receiver), and also based on the relationship between parameters, described hereinafter, which holds in the exhaust manifold model.

As is apparent from a comparison with FIG. 8, although the intake manifold model is provided with two input ports and one output port (two inputs/one output), the exhaust manifold model is provided one input port and two output ports (one input/two outputs), and hence there holds the following relationship between parameters, which is partially different from the case of the intake manifold model.

First, a relational expression based on the law of conservation of mass for the gases in the receiver is represented by the following equation (1)′ in place of the aforementioned equation (1) in the intake manifold model.

$$\frac{d}{dt} M = mdot 1 - mdot 2 - mdot 3 \qquad {( 1 )}^{′}$$

Further, relational expressions of conservation of a constant pressure heat capacity M1·Cp1 and a constant volume heat capacity M1·Cv1 of burned gases flowing into the receiver are represented by the following equations (4)′ and (6)′.

$$\begin{matrix}\frac{d}{dt} ( M 1 \cdot Cp 1 ) = mdot 1 \cdot Cp 1 - mdot 2 \cdot Cp 1 - mdot 3 \cdot Cp 1 & {( 4 )}^{′} \\ \frac{d}{dt} ( M 1 \cdot Cv 1 ) = mdot 1 \cdot Cv 1 - mdot 2 \cdot Cv 1 - mdot 3 \cdot Cv 1 & {( 6 )}^{′}\end{matrix}$$

Energy E1 of the burned gases flowing into the receiver, energy E2 of exhaust gases flowing out from the receiver toward the downstream side of the exhaust passage 7, and energy E3 of EGR gases flowing out from the receiver into the EGR passage 12 are similarly represented by the aforementioned equations (8) to (10). Further, the constant pressure heat capacity Cp·M and the constant volume heat capacity Cv·M of the gases in the receiver are represented by the following equations (11)′ and (12)′, respectively, and the heat dissipation amount Qwall from the receiver is similarly represented by the aforementioned equation (13).

Cp·M=Cp1·M1 (11)′

Cv·M=Cv1·M1 (12)′

Further, a relational expression based on the law of conservation of energy for the gases in the receiver is represented by the following equation (14)′, and the equation of state of the gas for the gases in the receiver is similarly represented by the above-mentioned equation (15).

$$\frac{d}{dt} ( T \cdot Cv \cdot M ) = E 1 - E 2 - E 3 - Qwall \qquad {( 14 )}^{′}$$

By applying simultaneous equations to the above equations (1)′, (4)′, (6)′, (8) to (10), (11)′, (12)′, (13), (14)′, and (15), it is possible to calculate the parameters of the gases in the receiver, the mass flow rate mdot2 and energy E2 of the exhaust gases flowing out from the receiver toward the exhaust passage 7, the mass flow rate mdot3 and energy E3 of the EGR gases flowing out toward the EGR passage 12, using the parameters of the burned gases flowing into the receiver as known parameters. In the step 3, a temperature T in the receiver is calculated as the exhaust manifold temperature Tex.

Referring again to FIG. 7, in steps 4 and 5 following the step 3, the temperature and pressure of EGR gases immediately upstream of the EGR valve 13 are calculated as the EGR temperature Tegr and the EGR pressure Pegr, respectively, followed by terminating the present process. As shown in FIG. 11, the calculation of the EGR temperature Tegr and the EGR pressure Pegr is performed by setting a portion of the EGR passage 12 from the branching portion from the exhaust passage 7 to a portion immediately upstream of the EGR valve 13a, as an EGR passage model (receiver), and also based on the relationship between the parameters, as described hereinafter, which holds in the EGR passage model.

As shown in FIG. 11, since the EGR passage model is provided one input port and one output port (one input/one output), there holds the following relationship between parameters, which is partially different from the cases of the intake manifold model and the exhaust manifold model described above.

A relational expression based on the law of conservation of mass for the gases in the receiver is represented by the following equation (1)″.

$$\frac{d}{dt} M = mdot 1 - mdot 2 \qquad {( 1 )}^{′′}$$

Further, relational expressions of conservation of the constant pressure heat capacity M1·Cp1 and the constant volume heat capacity M1·Cv1 of the EGR gases flowing into the receiver are represented by the following equations (4)″ and (6)″.

$$\begin{matrix}\frac{d}{dt} ( M 1 \cdot Cp 1 ) = mdot 1 \cdot Cp 1 - mdot 2 \cdot Cp 1 & {( 4 )}^{′′} \\ \frac{d}{dt} ( M 1 \cdot Cv 1 ) = mdot 1 \cdot Cv 1 - mdot 2 \cdot Cv 1 & {( 6 )}^{′′}\end{matrix}$$

The energy E1 of the EGR gases flowing into the receiver, and the energy E2 of the EGR gases flowing out from the receiver are similarly represented by the aforementioned equations (8) and (9). Further, the constant pressure heat capacity Cp·M and the constant volume heat capacity Cv·M of the gases in the receiver, and the heat dissipation amount Qwall from the receiver are similarly represented by the aforementioned equations (11)′, (12)′, and (13).

Further, a relational expression based on the law of conservation of energy for the gases in the receiver is represented by the following equation (14)″, and the equation of state of the gas for the gases in the receiver is similarly represented by the above-mentioned equation (15).

$$\frac{d}{dt} ( T \cdot Cv \cdot M ) = E 1 - E 2 - Qwall \qquad {( 14 )}^{′′}$$

By applying simultaneous equations to the above equations (1)″, (4)″, (6)″, (8), (9), (11)′, (12)′, (13), (14)″, and (15), it is possible to calculate the parameters of the gases in the receiver, using the parameters of the EGR gases flowing into the receiver as known parameters. In the step 4, the temperature T in the receiver is calculated as the EGR temperature Tegr, and in the step 5, the pressure P in the receiver is calculated as the EGR pressure Pegr.

Next, with reference to FIG. 12, a description will be given of an EGR control process executed by the engine controller 43. The present process is performed for each cylinder 3a in synchronism with generation of the TDC signal. In the present process, first, in a step 21, a target EGR amount GEGRCMD is set. This setting is performed e.g. by searching a predetermined map (not shown) according to target torque and the engine speed NE.

Next, a pressure function Ψ is calculated using the intake manifold pressure Pin calculated in the step 1 in FIG. 7 and the EGR pressure Pegr calculated in the step 5 in the same, by the following equation (19) (step 22).

$$Π = \frac{Pin}{Pegr} \\ WHEN Π < {( \frac{2}{κ + 1} )}^{\frac{κ}{κ - 1}} , ψ = ( \sqrt{κ \cdot {( \frac{2}{κ + 1} )}^{\frac{κ + 1}{κ - 1}}} ) \\ WHEN Π ≧ {( \frac{2}{κ + 1} )}^{\frac{κ}{κ - 1}} , ψ = {Π}^{\frac{1}{κ}} ( \sqrt{( \frac{2 κ}{κ} )} \cdot ( 1 - {Π}^{\frac{κ - 1}{κ}} ) ) \qquad ( 19 )$$

Next, a mass flow rate of EGR gases passing through the EGR valve 13a (hereinafter referred to as the “actual EGR amount”) GEGRACT is calculated using the EGR pressure Pegr, the pressure function Ψ, and the EGR temperature Tegr calculated in the step 4 in FIG. 7, by the following equation (20) (step 23).

$$GEGRACT = \frac{Cd \cdot A \cdot Pegr}{\sqrt{R \cdot Tegr}} \cdot ψ \qquad ( 20 )$$

This equation (20) is formed by applying the equation of the orifice to the EGR valve 13a, and in the equation, R represents a gas constant, and Cd represents a flow rate coefficient, which are both constants. Further, A represents an opening area of the EGR valve 13a, and is calculated based on the EGR valve opening LEGR.

Next, a target opening area ACMD, which is a target value of the opening area A of the EGR valve 13a, is set by the following equation (21) (step 24).

$$ACMD = \frac{GEGRCMD \cdot \sqrt{R \cdot Tegr}}{Cd \cdot Pegr \cdot ψ} \qquad ( 21 )$$

This equation (21) expresses the equation (20) of the orifice with respect to the opening area A, and is formed by replacing the actual EGR amount GEGRACT with the target EGR amount GEGRCMD, and the opening area A with the target opening area ACMD. Next, a difference between the target EGR amount GEGRCMD and the actual EGR amount GEGRACT is calculated as an EGR amount difference ΔGEGR (step 25), and a feedback correction term ΔAFB is calculated according to the EGR amount difference ΔGEGR (step 26). Then, by adding the feedback correction term ΔAFB to the target opening area ACMD, the target opening area ACMD is corrected (step 27).

Next, a target current value ICMD of the EGR actuator 13b for actuating the EGR valve 13a is set according to the corrected target opening area ACMD (step 28). Further, a difference between the target opening area ACMD and an actual opening area A calculated based on the EGR valve opening LEGR is calculated as an opening area difference ΔA (step 29), and a feedback correction term ΔIFB is calculated according to the opening area difference ΔA (step 30). Then, by adding the feedback correction term ΔIFB to the target current value ICMD, the target current value ICMD is corrected (step 31), followed by terminating the present process.

Next, a description will be given of a combustion model identification process. This identification process is for identifying (correcting) the model reference points PM1 to PM4 of the combustion model in real time based on an actual in-cylinder pressure PCYL detected by the in-cylinder pressure sensor 21, and comprises the combustion calculation process performed by the CPS calculation section 41, and an identification calculation process performed by the model calculation section 42 using results of the combustion calculation process.

The combustion calculation process shown in FIG. 13 is for calculating correction reference points PC1 to PC4 which are used as references for identifying the model reference points PM1 to PM4 of the combustion model, based on the in-cylinder pressure PCYL, and is performed for each cylinder 3a in synchronism with generation of the CRK signal. In the present process, first, in a step 41, the heat release rate dQd θ is calculated based on the in-cylinder pressure PCYL and the crank angle θ, by the following equation (22):

dQdθ=(V·dPCYLdθ+κ·PCYL·dV)/(κ−1) (22)

This gives, e.g. from a curve representing the in-cylinder pressure PCYL in FIG. 14(a), a curve representing the heat release rate dQd θ shown in the figure (b).

Next, in a step 42, the differential value dQd2 θ of the heat release rate is calculated by differentiating the heat release rate dQd θ with respect to the crank angle θ. This gives a curve representing the differential value dQd2 θ of the heat release rate shown in FIG. 14(c).

Next, in steps 43 to 46, as shown in FIGS. 14(b) to 14(d), the correction reference points PC1 to PC4 associated with the model reference points PM1 to PM4 are calculated, respectively, based on the heat release rate dQd θ and the differential value dQd2 θ of the heat release rate, followed by terminating the present process.

Specifically, in the step 43, out of values of the heat release rate dQd θ calculated in the step 41, a minimum value generated immediately before the start of combustion is extracted as a minimum heat release rate dQd θmina, and a point defined by a combination of the minimum heat release rate dQd θmina and a crank angle θmina associated therewith (θmina, dQd θmina) is set as a first correction reference point PC1.

In the step 44, the heat release rate dQd θ exhibited when a maximum value of the differential value dQd2 θ of the heat release rate calculated in the step 42 is obtained, is extracted as a maximum differential value-associated heat release rate dQd θmax2a, and a point defined by a combination of the maximum differential value-associated heat release rate dQd θmax2a and a crank angle θmax2a associated therewith (θmax2a, dQd θmax2a) is set as a second correction reference point PC2.

In the step 45, a maximum value of the heat release rate dQd θ is extracted as a maximum heat release rate dQd θmaxa, and a point defined by a combination of the maximum heat release rate dQd θmaxa and a crank angle θmaxa associated therewith (θmaxa, dQd θmaxa) is set as a third correction reference point PC3.

Further, in the step 46, the heat release rate dQd θ exhibited when a minimum value of the differential value dQd2 θ of the heat release rate is obtained, is extracted as a minimum differential value-associated heat release rate dQd θmin2a, and a point defined by a combination of the minimum differential value-associated heat release rate dQd θmin2a and a crank angle θmin2a associated therewith (θmin2a, dQd θmin2a) is set as a fourth correction reference point PC4.

Next, the identification calculation process performed by the model calculation section 42 will be described with reference to FIG. 15. The present process is for identifying (correcting) the model reference points PM1 to PM4 of the combustion model such that the model reference points PM1 to PM4 approximate the correction reference points PC1 to PC4 obtained in the same combustion cycle, respectively. The present process is performed for each cylinder 3a in synchronism with generation of the TDC signal.

In the present process, first, in a step 51, a crank angle correction term ΔθC1 of the first model reference point PM1 is calculated by multiplying a difference between θmina, which is a crank angle element of the first correction reference point PC1, and θmin, which is a crank angle element of the first model reference point PM1 (=θ mina−θmin), by a predetermined correction coefficient Kθ for correcting the crank angle.

Further, in a step 52, a heat release rate correction term ΔdQC1 of the first model reference point PM1 is calculated by multiplying a difference between dQd θmina, which is a heat release rate element of the first correction reference point PC1, and dQd θmin, which is a heat release rate element of the first model reference point PM1 (=dQd θmina−dQdθmin), by a predetermined correction coefficient KdQ for correcting the heat release rate.

Hereafter, similarly, as to the second model reference point PM2, in a step 53, a crank angle correction term ΔθC2 is calculated by multiplying a difference between the crank angle θmax2a of the second correction reference point PC2 and the crank angle θ max2 of the second model reference point PM2 (=θmax2a−θmax2), by the correction coefficient Kθ, and in a step 54, a heat release rate correction term ΔdQC2 is calculated by multiplying a difference between the heat release rate dQd θmax2a of the second correction reference point PC2 and the heat release rate dQd θmax2 of the second model reference point PM2 (=dQd θmax2a−dQd θmax2), by the correction coefficient KdQ.

As for the third model reference point PM3, in a step 55, a crank angle correction term ΔθC3 is calculated by multiplying a difference between the crank angle θmaxa of the third correction reference point PC3 and the crank angle θmax of the third model reference point PM3 (=θmaxa−θmax), by the correction coefficient Kθ, and in a step 56, a heat release rate correction term ΔdQC3 is calculated by multiplying a difference between the heat release rate dQd θmaxa of the third correction reference point PC3 and the heat release rate dQd θmax of the third model reference point PM3 (=dQd θmaxa−dQd θmax), by the correction coefficient KdQ.

Further, as to the fourth model reference point PM4, in a step 57, a crank angle correction term ΔθC4 is calculated by multiplying a difference between the crank angle θmin2a of the fourth correction reference point PC4 and the crank angle θmin2 of the fourth model reference point PM4 (=θmin2a−θmin2), by the correction coefficient Kθ, and in a step 58, a heat release rate correction term ΔdQC4 is calculated by multiplying a difference between the heat release rate dQd θmin2a of the fourth correction reference point PC4 and the heat release rate dQd θmax of the fourth model reference point PM4 (=dQd θmin2a−dQd θmin2), by the correction coefficient KdQ, followed by terminating the present process.

The crank angle correction terms ΔθC1 to ΔθC4 and the heat release rate correction terms ΔdQC1 to ΔdQC4, calculated as above, are added, in the next combustion cycle, to associated ones of the crank angle elements and the heat release rate elements of the first to fourth model reference points PM1 to PM4, calculated by map search according to operating conditions of the engine 3, whereby the first to fourth model reference points PM1 to PM4 are identified (corrected) in real time.

Next, with reference to FIG. 16, a description will be given of a failure determination process performed by the model calculation section 42. The present process is for determining whether or not the in-cylinder pressure sensor 21 is faulty, based on results of comparison between the first to fourth model reference points PM1 to PM4 and the correction reference points PC1 to PC4. The present process is performed for each cylinder 3a in synchronism with generation of the TDC signal.

In the present process, first, in a step 61, the absolute values of differences between the respective crank angle elements of the first to fourth correction reference points PC1 to PC4 and associated ones of the crank angle elements of the first to fourth model reference points PM1 to PM4 are calculated as crank angle differences Δθ1 to Δθ4, respectively. Next, it is determined whether or not all of the calculated crank angle differences Δθ1 to Δθ4 are equal to or smaller than a predetermined threshold value θREF for the crank angle (step 62). If the answer to this question is negative (NO), i.e. if at least one of the crank angle differences Δθ1 to Δθ4 exceeds the threshold value θREF, it is determined that the in-cylinder pressure sensor 21 is faulty, and a failure flag F_CYLNG is set to 1 (step 63), followed by terminating the present process.

If the answer to the question of the step 62 is affirmative (YES), in a step 64, the absolute values of differences between the respective heat release rate elements of the first to fourth correction reference points PC1 to PC4 and associated ones of the heat release rate elements of the first to fourth model reference points PM1 to PM4 are calculated as heat release rate differences ΔdQ1 to ΔdQ4, respectively. Next, it is determined whether or not all of the calculated heat release rate differences ΔdQ1 to ΔdQ4 are equal to or smaller than a predetermined threshold value dQREF for the heat release rate (step 65). If the answer to this question is negative (NO), i.e. if at least one of the heat release rate differences ΔdQ1 to ΔdQ4 exceeds the threshold value dQREF, it is determined that the in-cylinder pressure sensor 21 is faulty, and the process proceeds to the step 63, wherein the failure flag F_CYLNG is set to 1 (step 63), followed by terminating the present process.

On the other hand, if the answer to the question of the step 65 is affirmative (YES), it is determined that the in-cylinder pressure sensor 21 is not faulty, and the failure flag F_CYLNG is set to 0 (step 66), followed by terminating the present process. AS described above, in the case where it is determined that the in-cylinder pressure sensor 21 is faulty and the failure flag F_CYLNG is set to 1, the combustion calculation in FIG. 13 and the identification calculation in FIG. 14 to be performed based on a result of detection by the in-cylinder pressure sensor 21 are inhibited.

As described hereinabove, according to the present embodiment, the heat release rate dQd θ is calculated by the model calculation section 42 based on a combustion model of the plant model, which is set using the result of detection by the in-cylinder pressure sensor 21, so that it is possible to accurately calculate the heat release rate dQd θ while causing an actual pressure generated in each cylinders 3a to be reflected thereon.

Further, the model calculation section 42 and the engine controller 43 for controlling the engine 3 are each formed by the processor cores, and are provided in a single ECU 2, and hence the engine controller 43 can use the heat release rate dQd θ calculated by the model calculation section 42 in real time without communication delay. From the above, it is possible to improve the controllability of the EGR control using the heat release rate dQd θ.

Furthermore, since the intake manifold pressure Pin, the EGR temperature Tegr, and the EGR pressure Pegr, which are required for the EGR control, are determined by calculation based on the air system model of the plant model, it is possible to omit sensors provided for detecting them, whereby it is possible to achieve cost reduction.

Further, a combustion model is set by a linear function model equation obtained by approximating the Wiebe function by a plurality of linear functions, and the heat release rate dQd θ is calculated using the combustion model, so that it is possible to responsively perform the calculation of the heat release rate dQd θ in a short time period while maintaining its accuracy, whereby it is possible to further improve the controllability of the EGR control that uses the heat release rate dQd θ.

Furthermore, the model reference points PM1 to PM4 as model parameters of the combustion model are identified in real time by the correction reference points PC1 to PC4 that are calculated based on the result of detection by the in-cylinder pressure sensor 21, and hence it is possible to properly compensate for a modeling error of the combustion model due to variation in combustion states, aging, etc., as occasion arises, thereby making it possible to maintain excellent accuracy of calculation of the heat release rate dQd θ.

Further, since a failure of the in-cylinder pressure sensor 21 is determined based on results of comparison between the model reference points PM1 to PM4 and the correction reference points PC1 to PC4, it is possible to efficiently and properly determine a failure of the in-cylinder pressure sensor 21 while using parameters used for setting and identifying a combustion model.

Further, the CPS calculation section 41 that calculates the correction reference points PC1 to PC4 using the result of detection by the in-cylinder pressure sensor 21, the model calculation section 42, and the engine controller 43 are mounted on the processor cores of the ECU 2 separately from each other, and hence it is possible not only to perform each of the calculation of the correction reference points PC1 to PC4 by the CPS calculation section 41, the calculation of the heat release rate dQd θ and other engine parameters by the model calculation section 42, and the control of the engine 3 by the engine controller 43, at a high calculation speed or at a high control speed, but also to responsively supply and receive data to and from each other, so that it is possible to further improve the controllability of the engine 3.

Further, since the in-cylinder pressure sensor 21 is integrally provided at the tip end portion of the fuel injection valve 4, compared with a general washer type in-cylinder pressure sensor, it is possible to more accurately detect the in-cylinder pressure PCYL while suppressing the influence of vibration of the cylinder head 3c, and therefore it is possible to further improve the accuracy of calculating the heat release rate dQd θ using the in-cylinder pressure PCYL.

Note that the present invention is by no means limited to the above-described embodiment, but can be practiced in various forms. For example, although in the embodiment, the heat release rate dQd θ is calculated as a combustion parameter and is used to perform the EGR control for engine control, byway of example, this is not limitative, but as a combustion parameter, there may be calculated e.g. an illustrated average effective pressure, combustion torque, a maximum in-cylinder pressure angle at which the in-cylinder pressure becomes maximum, a crank angle at which a predetermined combustion mass rate can be obtained (e.g. MFB 50), or actual ignition timing. Further, according to results of calculation thereof, the fuel injection amount, the ignition timing, etc. may be controlled for engine control.

Further, although in the embodiment, the CPS calculation section 41, the model calculation section 42, and the engine controller 43 are mounted on the plurality of processor cores of the ECU 2 separately from each other, all or part thereof may be integrated into a single unit provided in the ECU 2.

Furthermore, although in the embodiment, the engine 3 is a four-cylinder gasoline engine, the type of the engine 3 and the number of the cylinder 3a may be set as desired. Further, although in the embodiment, the in-cylinder pressure sensor 21 is provided in each of all the cylinders 3a, the in-cylinder pressure sensor 21 may be provided in part of the cylinders 3a. Further, although in the embodiment, the engine 3 is for a vehicle, this is not limitative, but the present invention can be applied to various engines other than the engine for a vehicle, e.g. engines for ship propulsion machines, such as an outboard motor having a vertically-disposed crankshaft. It is to be further understood that various changes and modifications may be made without departing from the spirit and scope of the invention.

### REFERENCE SIGNS LIST

2 ECU (electronic control unit)

3 engine (internal combustion engine)

3a cylinder

4 fuel injection valve

21 in-cylinder pressure sensor

41 CPS calculation section (processor core, combustion calculation section)

42 model calculation section (processor core, plant model, identification means)

43 engine controller (processor core, controller)

PCYL in-cylinder pressure (result of detection by in-cylinder pressure sensor)

dQd θ heat release rate (combustion parameter)

Pin intake manifold pressure (engine parameter)

Tegr EGR temperature (engine parameter)

Pegr EGR pressure (engine parameter)

PM1 to PM4 model reference points (model parameters)

PC1 to PC4 correction reference points (results of detection by in-cylinder pressure sensor)

θ crank angle

1. A control apparatus for an internal combustion engine, comprising:
an in-cylinder pressure sensor that detects pressure in a cylinder;
a plant model that is provided in an electronic control unit, and includes a combustion model for calculating a combustion parameter indicative of a combustion state in the cylinder using a result of detection by the in-cylinder pressure sensor, for calculating engine parameters indicative of states of the engine, including the combustion parameter;
a controller that is provided in the electronic control unit, for controlling the engine using the engine parameters calculated by the plant model.

2.The control apparatus according to claim 1, wherein the combustion parameter is a heat release rate, and
wherein the combustion model calculates the heat release rate using a linear function model equation obtained by approximating a Wiebe function which is an approximate function of the heat release rate by a plurality of linear fiinctiom.

3. The control apparatus according to claim 2, wherein the linear function model equation includes a plurality of model parameters, and
wherein the combustion model includes identification means for identifying the plurality of model parameters in real time based on the result of detection by the in-cylinder pressure sensor.

4. The control apparatus according to claim 1, wherein the electronic control unit includes a plurality of processor cores, and a combustion calculator for performing combustion calculation using the result of detection by the in-cylinder pressure sensor, the plant model, and the controller are mounted on the plurality of processor cores separately from each other.

5. The control apparatus according to claim 1, wherein the engine includes a fuel injection valve for injecting fuel directly into each cylinder, and wherein the in-cylinder pressure sensor is integrally provided on the fuel injection valve.

6. The control apparatus according to claim 2, wherein the electronic control unit includes a plurality of processor cores, and a combustion calculator for performing combustion calculation using the result of detection by the in-cylinder pressure sensor, the plant model, and the controller are mounted on the plurality of processor cores separately from each other.

7. The control apparatus according to claim 3, wherein the electronic control unit includes a plurality of processor cores, and a combustion calculator for performing combustion calculation using the result of detection by the in-cylinder pressure sensor, the plant model, and the controller are mounted on the plurality of processor cores separately from each other.

8. The control apparatus according to claim 2, wherein the engine includes a fuel injection valve for injecting fuel directly into each cylinder, and
wherein the in-cylinder pressure sensor is integrally provided on the fuel injection valve.

9. The control apparatus according to claim 3, wherein the engine includes a fuel injection valve for injecting fuel directly into each cylinder, and
wherein the in-cylinder pressure sensor is integrally provided on the fuel injection valve.

10. The control apparatus according to claim 4, wherein the engine includes a fuel injection for injecting fuel directly into each cylinder, and
wherein the in-cylinder pressure sensor is integrally provided on the fuel injection valve.

11. The control apparatus according to claim 6, wherein the engine includes a fuel injection valve for injecting fuel directly into each cylinder, and
wherein the in-cylinder pressure sensor is integrally provided on the fuel injection valve.

12. The control apparatus according to claim 7, wherein the engine includes a fuel injection valve for injecting fuel directly into each cylinder, and
wherein the in-cylinder pressure sensor is integrally provided on the fuel. injection valve.
